(19) United States
(12) Patent Application Publication
(10) Pub. No.: US 2022/0074752 A1
(43) Pub. Date: Mar. 10, 2022

(54) INFORMATION PROCESSING DEVICE, INFORMATION PROCESSING METHOD, AND STORAGE MEDIUM

(71) Applicant: HONDA MOTOR CO., LTD., Tokyo (JP)

(72) Inventors: Makoto Nagai, Tokyo (JP); Yo Ito, Tokyo (JP)

(21) Appl. No.: 17/465,918

(22) Filed: Sep. 3, 2021

(30) Foreign Application Priority Data
Sep. 7, 2020 (JP) 2020-149771

(51) Int. Cl. G01C 21/34; G01C 21/36

(52) U.S. Cl. CPC G01C 21/3492; G01C 21/3617; G01C 21/3484

(57) ABSTRACT

An information processing device according to an embodiment includes an acquirer configured to acquire user information regarding a movement of a user from a user terminal used by the user, an estimator configured to estimate a first movement method of the user on the basis of the user information, a determiner configured to determine a third movement method different from the first movement method on the basis of a second movement method that is a movement method performed in the past by the user or another user having a movement history similar to a movement history of the user, and a notification unit configured to notify the user of the third movement method before the user starts a movement in the first movement method.

### CROSS-REFERENCE TO RELATED APPLICATION

This application is based upon and claims the benefit of priority from Japanese Patent Application No. 2020-149771, filed Sep. 7, 2020, the entire content of which is incorporated herein by reference.

### BACKGROUND

### Field of the Invention

The present invention relates to an information processing device, an information processing method, and a storage medium.

### Description of Related Art

Conventionally, for example, a technology for providing guidance on a route from a start point to a destination according to a movement device used by a user (for example, refer to Japanese Unexamined Patent Application, First Publication No. 2020-112565) is known as a technology for supporting the movement of the user.

### SUMMARY

However, with the conventional technology, there have been cases in which it may not be possible to propose to the user a movement method that can replace the usual movement method in a timely manner.

The present invention has been made in consideration of such circumstances, and an object thereof is to provide an information processing device, an information processing method, and a storage medium that can propose to a user a movement method that can replace the usual movement method in a timely manner.

The information processing device, the information processing method, and the storage medium according to this invention have adopted the following configuration.

(1) According to a first aspect of the present invention, an information processing device includes an acquirer configured to acquire user information regarding a movement of a user from a user terminal used by the user, an estimator configured to estimate a first movement method of the user on the basis of the user information, a determiner configured to determine a third movement method different from the first movement method on the basis of a second movement method that is a movement method performed in the past by the user or another user having a movement history similar to a movement history of the user, and a notification unit configured to notify the user of the third movement method before the user starts a movement in the first movement method.

(2) According to a second aspect of the present invention, in the first aspect, the user information includes at least section information, and the determiner extracts a movement history that has the same start point and destination and has a short movement distance from the start point to the destination as the movement history similar to the movement history of the user.

(3) According to a third aspect of the present invention, in the first or second aspect, the determiner determines the third movement method on the basis of a movement time required for a movement in the second movement method.

(4) According to a fourth aspect of the present invention, in any one of the first to third aspects, the determiner determines the third movement method on the basis of a charge required for a movement in the second movement method.

(5) According to a fifth aspect of the present invention, in any one of the first to fourth aspects, the determiner determines the third movement method on the basis of a service that is usable as the user moves.

(6) According to a sixth aspect of the present invention, in the fourth aspect, the information processing device further includes a reward granting unit configured to perform processing for giving a reward in accordance with an achievement of the user using the service to a provider of the service.

(7) According to a seventh aspect of the present invention, in any one of the first to sixth aspects, the determiner determines the third movement method of each of a plurality of users such that a traffic volume in an area to which the users move is reduced by the plurality of users performing a movement in the third movement method of which each user is notified.

(8) According to an eighth aspect of the present invention, an information processing method includes, by a computer, acquiring user information regarding a movement of a user from a user terminal used by the user, estimating a movement method of the user as a first movement method on the basis of the user information, determining a third movement method different from the first movement method on the basis of a second movement method that is a movement method performed in the past by the user or another user having a movement history similar to a movement history of the user, and notifying the user of the third movement method before the user starts a movement in the first movement method.

(9) According to a ninth aspect of the present invention, a computer readable non-transitory storage medium stores a program for causing a computer to execute acquiring user information regarding a movement of a user from a user terminal used by the user, estimating a movement method of the user as a first movement method on the basis of the user information, determining a third movement method different from the first movement method on the basis of a second movement method that is a movement method performed in the past by the user or another user having a movement history similar to a movement history of the user, and notifying the user of the third movement method before the user starts a movement in the first movement method.

According to (1), (2), (8), and (9), it is possible to propose to a user a movement method that can replace a usual movement method in a timely manner by acquiring user information regarding a movement of a user from a user terminal used by the user, estimating a movement method of the user as a first movement method on the basis of the user information, determining a third movement method different from the first movement method on the basis of a second movement method that is a movement method performed in the past by the user or another user having a movement history similar to a movement history of the user, and notifying the user of the third movement method before the user starts the movement in the first movement method.

According to (3), it is possible to propose a movement method in which a destination can be reached within an appropriate required time while improving an added value of a movement time of a user by determining the third movement method on the basis of the movement time required for a movement in the second movement method.

According to (4), it is possible to propose a movement method in which a destination can be reached with an appropriate amount of charge while improving the added value of a movement time by determining the third movement method on the basis of a charge required for the movement in the second movement method.

According to (5), it is possible to propose to a user a service that can improve the added value of the time required for a movement to a destination by determining the third movement method on the basis of a service that can be used while the user moves in the movement method.

According to (6), it is possible to improve a motivation of a service provider to provide better service to a user by giving a reward according to an achievement of the user using the service to a provider of the service.

According to (7), it is possible to suppress traffic congestion or traffic accidents near a movement route by determining a third movement method of each of a plurality of users such that a traffic volume is averaged by the plurality of users performing a movement in the third movement method of which each user is notified.

### BRIEF DESCRIPTION OF THE DRAWINGS

FIG. 1 is a diagram which shows an outline of a movement-related service providing system in the present embodiment.

FIG. 2 is a diagram which shows an example of a system configuration of a movement-related service providing system in the present embodiment.

FIG. 3 is a diagram which shows an example of user management information in the present embodiment.

FIG. 4 is a diagram which shows an example of provider management information in the present embodiment.

FIG. 5 is a flowchart which shows an example of processing in which a service management device of the present embodiment proposes a recommended movement method to a user of a movement-related service providing system.

FIG. 6 is a diagram which shows a display example of service information in the present embodiment.

FIG. 7 is a flowchart which shows an example of first reward granting processing in the present embodiment.

FIG. 8 is a flowchart which shows an example of second reward granting processing in the present embodiment.

### DESCRIPTION OF EMBODIMENTS

Hereinafter, embodiments of an information processing device, an information processing method, and a storage medium of the present invention will be described with reference to the drawings. In the following description, one “movement” means starting from a certain start point and reaching a certain destination. In addition, a “movement method” in the following description includes at least a route from the start point to the destination (hereinafter, referred to as a “movement route”), and may include a device that moves along a path of the movement route (hereinafter, referred to as a “movement device”) and a timing at which the movement is performed (hereinafter, referred to as a “movement timing”).

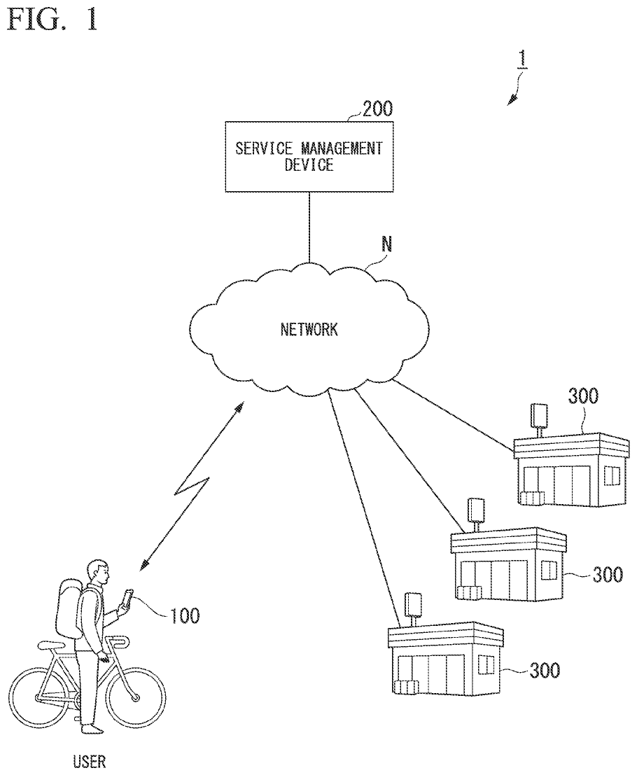

FIG. 1 is a diagram which shows an outline of a movement-related service providing system 1 in the present embodiment. The movement-related service providing system 1 is a system that proposes a movement method with a higher added value to a user. More specifically, the movement-related service providing system 1 is a system that proposes to a user the movement method together with various services (hereinafter, referred to as “movement-related services”) that can be received by moving from a start point to a destination in a predetermined movement method. Here, the movement-related service may be any service as long as it can be received by a user performing the movement in a proposed movement method. For example, the movement-related service may be a service provided to a moving user, or it may also be a service provided to a user on the basis of an achievement of the movement in the proposed movement method.

In order to provide such a movement-related service, the movement-related service providing system 1 of the embodiment includes a user terminal 100 used by a user, a service management device 200, and a service provider 300 of a movement-related service. The user terminal 100, the service management device 200, and the service provider 300 are communicably connected to each other via a network N.

The user terminal 100 is a terminal device used by a user to use the movement-related service providing system 1. For example, the user terminal 100 is a portable wireless communication terminal such as a smartphone or tablet, and connects to the network N via a wireless communication line such as a cellular network. For example, an application that provides a movement-related service to the user in linkage with a service management device 20 (hereinafter, referred to as a “service app”) is installed in the user terminal 100. For example, the service app receives an input of information regarding a user who uses the movement-related service providing system 1 (hereinafter, referred to as “user information”), and transmits the input user information to the service management device 200. In addition, the user terminal 100 receives information regarding a movement-related service (hereinafter, referred to as “service information”) from the service management device 200, and notifies the user of the received service information. The user can recognize contents of a movement method and a movement-related service proposed by the movement-related service providing system 1 according to the notified service information.

The service management device 200 has a function of managing various types of information regarding the provision of a movement-related service. Specifically, the service management device 200 stores management information regarding a user who uses the movement-related service (hereinafter, referred to as “user management information”) and management information of the service provider 300 which provides the movement-related service (hereinafter, referred to as “provider management information”). The user management information is generated on the basis of user information acquired from the user terminal 100 of each user, and the provider management information is generated on the basis of provider information acquired from each service provider 300. The service management device 200 extracts a movement-related service to be proposed to the user on the basis of these types of management information, and proposes to the user this extracted movement-related service together with a movement method in which the movement-related service can be received (hereinafter, referred to as a “recommended movement method”).

The service provider 300 is a business operator that provides a movement-related service to the user via the service management device 200. The service provider 300 registers the movement-related service that can be provided in the service management device 200 in advance together with the provision conditions. The movement-related service registered in the service management device 200 is matched with a user who is moving in a movement method that meets provision conditions, and the user is notified of. Note that the service provider 300 may register a service that does not distinguish between a user of the movement-related service providing system 1 and another user as a movement-related service, or register a service that is provided only to the user of the movement-related service providing system 1 as a movement-related service. Moreover, when a movement-related service is provided, when the user is identified as the user of the movement-related service providing system 1, the service provider 300 can notify the service management device 200 of information regarding a service use of the user.

With such a configuration, the movement-related service providing system 1 can propose a movement method in which various movement-related services are received during a movement (hereinafter, referred to as a “recommended movement method”) to a user who starts moving to a destination. For this reason, according to the movement-related service providing system 1 of the embodiment, since the user can use various movement-related services by utilizing a movement time to the destination, an added value of the movement time can be improved. In the following description, a configuration of the movement-related service providing system 1 that exerts such an effect will be described in detail.

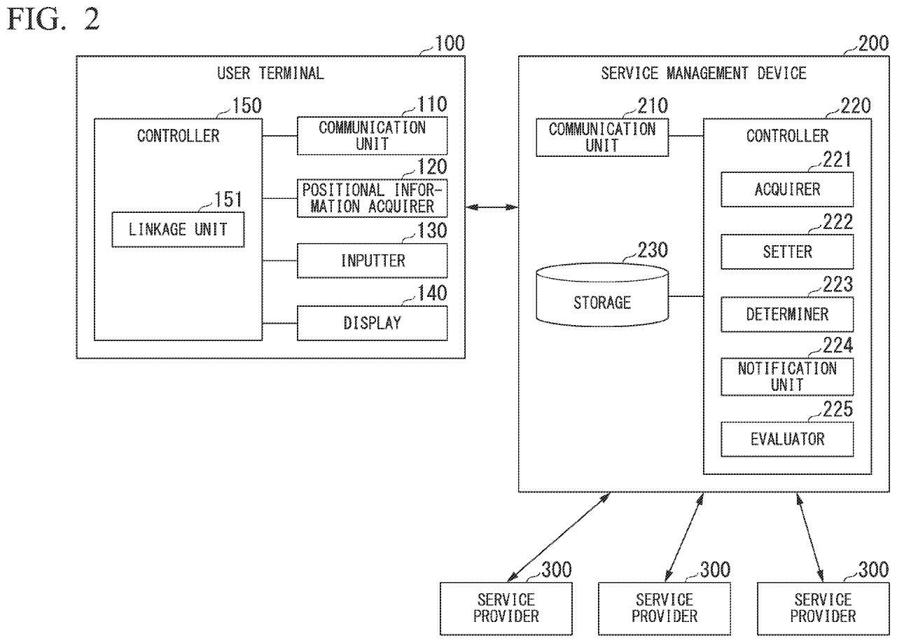

FIG. 2 is a diagram which shows an example of a system configuration of the movement-related service providing system 1 in the present embodiment. The user terminal 100 includes a communication unit 110, a positional information acquirer 120, an inputter 130, a display 140, a controller 150, and a storage 160. These components are realized by, for example, a hardware processor such as a central processing unit (CPU) executing a program (software). Some or all of these components may be realized by hardware (a circuit unit; including circuitry) such as Large Scale Integration (LSI), an Application Specific Integrated Circuit (ASIC), a Field-Programmable Gate Array (FPGA), or a Graphics Processing Unit (GPU), or may be realized by the cooperation of software and hardware. The program may be stored in advance in a storage device (a storage device having a non-transitory storage medium) such as a hard disk drive (HDD) or a flash memory, or may also be stored in a detachable storage device (a non-transitory storage medium) such as a DVD or a CD-ROM and installed by the storage medium being mounted on a drive device.

The communication unit 110 is a wireless communication interface for connecting the user terminal 100 to the network N. For example, the communication unit 110 wirelessly connects to a base station such as a cellular network, and connects to the network N via the base station. The communication unit 110 communicates with the service management device 200 and the service provider 300 via the network N.

The positional information acquirer 120 acquires positional information of the user terminal 100. The positional information acquirer 120 is, for example, a global positioning system (GPS) sensor. The positional information acquirer 120 outputs the acquired positional information to the controller 150.

The inputter 130 is configured by using, for example, input devices such as a keyboard, a mouse, and a touch panel. The inputter 130 receives inputs for various operations to the user terminal 100. The inputter 130 outputs the input information to the controller 150.

The display 140 is configured by using, for example, a display device such as a liquid crystal display, or an organic electro-luminescence (EL) display. The display 140 displays various types of information output from the controller 150. The display 140 may be integrated with the inputter 130 using a touch panel.

The controller 150 controls an operation of the user terminal 100. Specifically, the controller 150 includes a linkage unit 151 that realizes a linkage function between the service management device 200 and each service provider 300 in addition to having a function of controlling an input or output among the communication unit 110, the positional information acquirer 120, the inputter 130, the display 140, and the storage 160. The linkage unit 151 is realized by, for example, executing the service app.

Specifically, the linkage unit 151 transmits information necessary for receiving a proposal of a recommended movement method from the movement-related service providing system 1 to the service management device 200 as user information. For example, the linkage unit 151 transmits the positional information of the user terminal 100 acquired by the positional information acquirer 120, or information such as a movement device, movement conditions, a start point, a destination, and a movement time, which is input to the user terminal 100 by a user with respect to his or her movement as user information. In addition, on the other hand, the linkage unit 151 has a function of acquiring a recommended movement method, and service information from the service management device 200 as information regarding a movement-related service which is received by performing movement in the recommended movement method from the service management device 200 and notifying a user of these. For example, the linkage unit 151 causes the display 140 to display the contents of the acquired service information.

The storage 160 is configured by using, for example, a magnetic storage device such as a hard disk drive (HDD) or a semiconductor storage device such as a solid state drive (SSD). The storage 160 stores various types of information related to the operation of the user terminal 100. For example, a program of the service app is stored in the storage 160. Moreover, for example, the storage 160 may store the positional information acquired by the positional information acquirer 120, the service information acquired from the service management device 200, and the like.

Subsequently, the configuration of the service management device 200 will be described. The service management device 200 includes a communication unit 210, a controller 220, and a storage 230. These components are realized by, for example, a hardware processor such as a CPU executing a program (software). Some or all of these components may be realized by hardware (a circuit unit; including circuitry) such as LSI, an ASIC, an FPGA, or a GPU, or may be realized by the cooperation of software and hardware. The program may be stored in advance in a storage device (a storage device having a non-transitory storage medium) such as an HDD or a flash memory, or may also be stored in a detachable storage medium (a non-transitory storage medium) such as a DVD or a CD-ROM and installed by the storage medium being mounted on a drive device.

The communication unit 210 is a communication interface for connecting the service management device 200 to the network N. The communication unit 210 may be a wireless communication interface or a wired communication interface. The communication unit 210 communicates with the user terminal 100 and the service provider 300 via the network N.

The controller 220 controls the operation of the service management device 200. Specifically, the controller 220 includes an acquirer 221, a setter 222, a determiner 223, a notification unit 224, and an evaluator 225 as a configuration for realizing a function of linking the user terminal 100 with each service provider 300 in addition to having a function of controlling the input and output between the communication unit 210 and the storage 230.

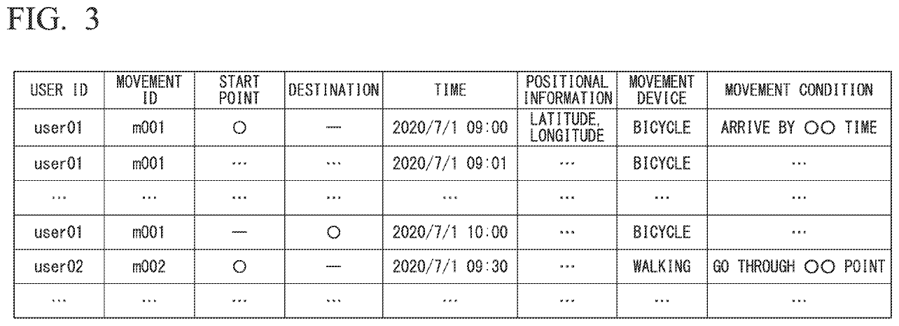

The acquirer 221 acquires user information from the user terminal 100 of each user. The acquirer 221 records a result of associating user identification information with the acquired user information in the storage 230 as user management information. FIG. 3 is a diagram which shows an example of the user management information. For example, FIG. 3 shows an example in which a user ID that is the identification information of a user and a movement ID that is the identification information of each movement are associated with user information including a start point, a destination, a movement time, positional information, a movement device, and a movement condition. Here, a user ID may be acquired from each user terminal 100 as user information, or may be assigned when the acquirer 221 acquires user information from each user terminal 100. In addition, a movement ID is identification information of each movement identified according to a start point, a destination, a user ID, a movement time, and the like. The acquirer 221 identifies each individual movement of each user on the basis of the acquired user information, and assigns a movement ID to each identified movement. The user ID and the movement ID may be assigned on the user terminal 100.

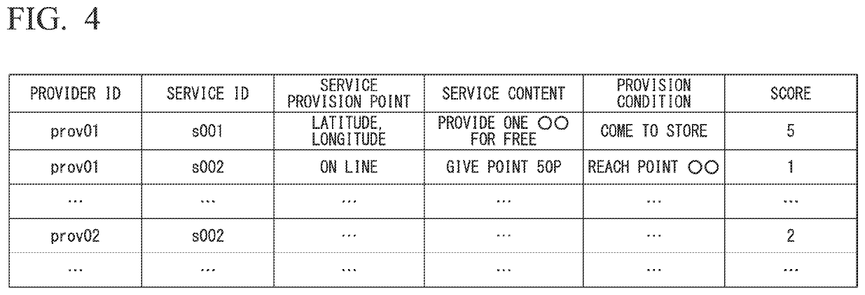

Moreover, the acquirer 221 acquires information on a movement-related service provided by the service provider 300 (hereinafter, referred to as “provider information”) from the service provider 300. For example, the acquirer 221 acquires information such as the contents of the movement-related service provided by the service provider 300 and provision conditions as provider information. In addition, the acquirer 221 may acquire information such as usage achievement of the movement-related service as provider information. The acquirer 221 records provider information acquired from each service provider 300 in the storage 230 as provider management information. FIG. 4 is a diagram which shows an example of such provider management information. For example, as shown in FIG. 4, the provider management information is managed as information in which a provider ID that is identification information of the service provider 300, a service ID that is identification information of a movement-related service provided by the service provider 300, a service provision point indicating a provision location of a movement-related service, service contents of a movement-related service, provision conditions of a movement-related service, and a score of a movement-related service are associated with each other.

Here, the score of a movement-related service is a numerical value of an amount of added value added by the movement-related service. FIG. 4 shows an example in which the score value is set as a fixed value for each movement-related service, but the score value does not necessarily have to be a fixed value. For example, the score value may be set as a different value for each user for the same movement-related service, or may be set as a variable value according to a provision time. In addition, the score value may be determined based on any criteria.

The setter 222 sets a movement method of a target (hereinafter referred to as a “target movement method”) for proposing a recommended movement method for each user. In other words, a recommended movement method is proposed as a movement method that can replace a target movement method determined by the setter 222. Specifically, the setter 222 sets a usual movement method of a user estimated on the basis of a past movement achievement of the user as a target movement method. For example, the setter 222 specifies a section with the highest movement frequency for each user on the basis of the user information, and specifies a movement route and a movement device with the highest frequency of use in the movement of the section. The setter 222 sets a start point and an end point of the section specified in this manner as a start point and a destination, and sets a movement method for moving using the movement route in which a path from the start point to the destination is specified and the movement device as the target movement method. The target movement method is an example of a first movement method in the present invention. The setter 222 is an example of an estimator in the present invention.

As mentioned at the beginning, the movement method in the present embodiment includes a movement route from the start point to the destination, and may include a movement device and a movement timing. In this sense, the setter 222 may set a movement method in which a movement device is not specified as the target movement method, or may also set a movement method in which a movement timing is specified in addition to a movement route and a movement device as the target movement method. When a movement timing is specified, the setter 222 may specify a timing with the highest movement frequency as a movement timing of the target movement method, in the same manner as the movement route and movement device.

In addition, as another method for setting the target movement method, the setter 222 may set a specific movement method designated in advance by each user as the target movement method. In this case, the specific movement method designated by a user may be acquired from each user terminal 100 as user information. The setter 222 records setting information of the target movement method set in this manner in the storage 230.

The determiner 223 determines a recommended movement method for the target movement method set for each user. Specifically, for a target user (hereinafter referred to as a “target user”) who proposes a recommended movement method, the determiner 223 extracts a movement method performed in the past by the target user or another user having a movement history similar to the target user as another movement method similar to a target movement method (hereinafter referred to as a “similar movement method”), and determines a recommended movement method on the basis of the extracted similar movement method. Here, a similar movement method is a movement method with similar components of a movement method (a movement route, a movement device, a movement timing, and the like), and a degree of required similarity may be arbitrarily set. The similar movement method is an example of a second movement method in the present invention.

For example, the determiner 223 may extract a movement method with a start point and a destination that match those of the target movement method as a similar movement method. Moreover, for example, the determiner 223 may extract a movement method with a movement distance from a start point to a destination close to that of the target movement method as a similar movement method. Furthermore, for example, the determiner 223 may extract a movement method that satisfies both of these conditions as a similar movement method.

For example, the determiner 223 may also determine a movement method that satisfies movement conditions of the target movement method among the extracted similar movement methods as a recommended movement method. Moreover, for example, the determiner 223 may determine a representative movement method (for example, an average of a plurality of similar movement methods) obtained by statistical processing of a plurality of similar movement methods as a recommended movement method. Furthermore, for example, the determiner 223 may determine a movement method with the highest index value regarding movement-related services that a user can receive in the movement route among a plurality of similar movement methods as a recommended movement method. The recommended movement method is an example of a third movement method in the present invention. The determiner 223 notifies the notification unit 224 of a recommended movement method determined in this manner.

The notification unit 224 generates service information for notifying a user of the recommended movement method notified of by the determiner 223, and notifies the user terminal 100 of the user of the generated service information. Specifically, the notification unit 224 generates service information including information indicating the recommended movement method and information on the movement-related service that can be used by the user by performing a movement in the recommended movement method. Moreover, the notification unit 224 notifies the user terminal 100 of the user of the generated service information before the user starts the movement in the target movement method according to the service information.

The evaluator 225 performs processing for giving a predetermined reward to a user or the service provider 300 of a movement-related service according to the recommended movement method with respect to a movement based on the recommended movement method performed by the user. For example, the processing for giving a reward may be processing for giving points or processing for issuing a coupon. The evaluator 225 is an example of a reward granting unit in the present invention.

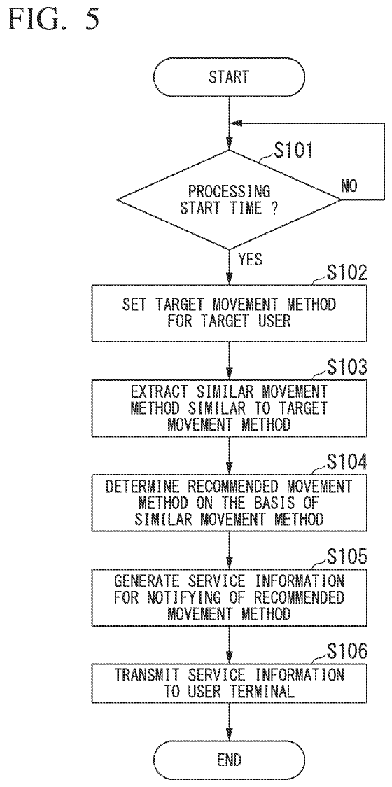

FIG. 5 is a flowchart which shows an example of processing in which the service management device 200 of the present embodiment proposes a recommended movement method to a user of the movement-related service providing system 1. In the following description, a target user who proposes a recommended movement method is referred to as a “target user.” In addition, at a start time of this flowchart, it is assumed that user information sufficient to determine a recommended movement method for a target user is accumulated as user management information in the service management device 200.

First, the setter 222 determines whether a time for starting the processing for proposing a recommended movement method for a target user (hereinafter referred to as a “processing start time”) has arrived (step S101). Here, a processing start time is a time determined so that a target user can be notified of a recommended movement method for a target movement method before the target user starts the movement in the target movement method. Specifically, the processing start time is set as a time earlier than a time going back from a time at which the target user starts the movement in the target movement method (hereinafter referred to as a “movement start time”) by a time required for processing of determining a recommended movement method. It is assumed that a movement start time of the target user is registered in the service management device 200 by the user before the processing start time arrives.

When it is determined in step 5101 that the processing start time has not arrived, the setter 222 repeatedly executes step S101 until it is determined that the processing start time has arrived. On the other hand, when the setter 222 determines that the processing start time has arrived in step S101, the setter 222 sets a target movement method of a target that proposes a recommended movement method for a target user based on user information acquired for the target user (step S102).

If a target movement method is set for the target user by the setter 222, the determiner 223 subsequently extracts a similar movement method similar to the set target movement method from movement methods of movements performed in the past (step S103). For example, the determiner 223 may extract, as a similar movement method, a movement method in which some or all of a movement route, a movement time, a movement device, a movement condition, and the like are the same or similar among the movements performed in the past. In addition, the determiner 223 may also extract a similar movement method on the basis of similarity of other attributes related to the movements performed in the past, such as weather and traffic conditions during a movement. In this case, it is assumed that information indicating other attributes related to the movements of a user in the past is appropriately acquired by the acquirer 221.

Subsequently, the determiner 223 determines a recommended movement method for the target movement method on the basis of the extracted similar movement method (step S104). The determiner 223 notifies the notification unit 224 of the determined recommended movement method. For example, when an arrival time is set as a movement condition of the target movement method (movement ID=m001) as in the user management information shown in FIG. 3, the determiner 223 may determine, as a recommended movement method, a movement method in which a user reaches a destination by an arrival time set in the movement conditions among the extracted similar movement methods. In addition, for example, as in the user management information shown in FIG. 3, when a waypoint to a destination is set as the movement condition of the target movement method (movement ID=m002), the determiner 223 may determine a movement method through the waypoint set as a movement condition to the destination among the extracted similar movement methods as the recommended movement method.

Moreover, for example, when a charge allowed for movement is set as the movement condition of the target movement method in the user management information, the determiner 223 may also determine a movement method in which a charge required for movement equal to or less than the charge set as the movement condition as the recommended movement condition among the extracted similar movement methods. In addition, the charge allowed for movement may include a usage charge of a movement-related service that can be used in the middle of a movement route, in addition to a usage charge of a movement device. In this case, the determiner 223 may determine the recommended movement method such that a total of the usage charge of a movement-related service and the usage charge of a movement device, which is proposed to a user, is equal to or less than the amount set as the movement condition.

Furthermore, for example, when the score of added value is set for a movement-related service provided by each service provider 300 as in the provider management information shown in FIG. 4, the determiner 223 may determine, as the recommended movement method, a movement method of using a movement route in which a sum of the scores of movement-related services (hereinafter referred to as “available services”) that a user can receive in the middle of the route is a maximum among movement routes that lead to the destination from the start point of the target movement method.

Subsequently, the notification unit 224 generates service information for notifying the target user of the recommended movement method notified of by the determiner 223 (step S105). The notification unit 224 transmits the generated service information to the user terminal 100 of the target user (step S106).

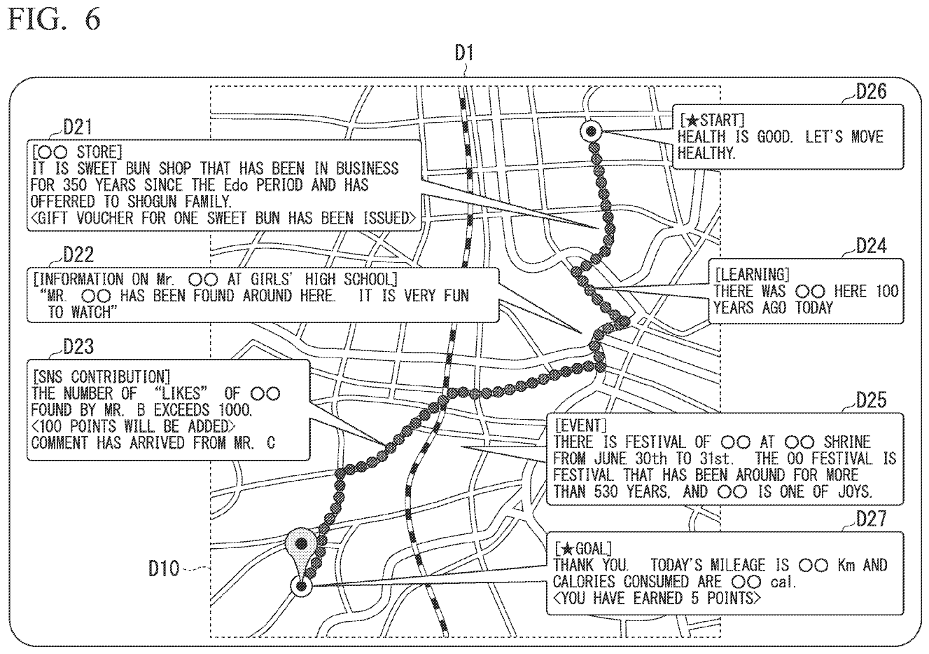

FIG. 6 is a diagram which shows a display example of service information in the present embodiment. For example, FIG. 6 shows a service information screen D1 as an example of a screen displaying service information generated in relation to a movement from a start point A to a destination B. The service information screen D1 has a first display D10 indicating the recommended movement method, and second displays D21 to D27 indicating various movement-related information of which a user is notified regarding a movement in a corresponding movement method. For example, the first display D10 is represented by a map including the start point A and the destination B, an icon indicating the start point A and the destination B on the map, a display of a time required to reach each waypoint, and a display of a movement route from the start point A to the destination B. The first display D10 is generated on the basis of the recommended movement method included in the service information. Moreover, the first display D10 may be generated by the service app, or may be generated by the service app using a function of another application.

Furthermore, the second displays D21 to D27 are displayed in association with each point on the map represented by the first display D10. FIG. 6 is an example in which the second displays D21 to D27 are displayed to be superimposed on the first display D10. For example, the second display D21 shows business information of “∘∘ store” as an example of the service that can be used for a user during the movement along a movement route. Business information may be information indicating the content of normal business, or may be information indicating content of various campaigns. For example, a second display D21 is generated on the basis of provider information of each service provider 300 registered in advance in the service management device 200 as provider management information.

Furthermore, for example, a second display D22 is an example of a display showing recommended information of another user. For example, recommended information may be acquired from the user terminal 100 of each user by the acquirer 221 as a part of the user information. In addition, the acquirer 221 may acquire the recommended information of each user in linkage with other online services such as social network service (SNS). Moreover, the recommended information may be acquired by linking the service app with other online services. Furthermore, the recommended information acquired by the user terminal 100 may be transmitted to the service management device 200 as a part of the user information, or may be displayed on the service information screen D1 together with the service information acquired from the service management device 200.

In addition, for example, a second display D23 is an example of a notification regarding information shared with other users by a target user (hereinafter referred to as “shared information”). For example, shared information may be information transmitted to a number of unspecified users, or may be information transmitted to a specified user. In addition, the shared information may be transmitted by the service app, or by linking the service app with other online services. In this case, the notification unit 224 may acquire evaluation information of another user with respect to the shared information transmitted by the target user, and display a second display indicating the acquired evaluation information on the service information screen Dl. The evaluation information may be a value indicating the evaluation amount of another user, a comment of a specified user, or the like. Furthermore, in this case, the evaluator 225 may give a reward to the target user according to the evaluation amount of another user. Furthermore, in this case, the notification unit 224 may notify the user that a reward has been given to the target user according to the second display.

Moreover, for example, second displays D24 and D25 are examples of a second display showing knowledge information on each point as movement-related information. For example, knowledge information may be acquired from the user terminal 100 of each user as a part of the user information by the acquirer 221. Moreover, the acquirer 221 may acquire knowledge information on each point in linkage with other online services such as a content management system (CMS) that provides various types of information. In addition, the knowledge information may be acquired by linking the service app with other online services. Furthermore, the knowledge information acquired by the user terminal 100 may be transmitted to the service management device 200 as a part of the user information, or may also be displayed on the service information screen D1 together with the service information acquired from the service management device 200.

Furthermore, for example, a second display D26 is an example of a second display showing information on a health state of a user (hereinafter referred to as “health state information”) as movement-related information. For example, the second display D26 shown in FIG. 6 notifies a user who starts the movement in a recommended movement method that the user is in good health. For example, health state information may be acquired from the user terminal 100 of each user by the acquirer 221 as a part of the user information. In addition, the acquirer 221 may acquire the health state information of a user in linkage with other on-line services that manage the health state of a user. In addition, the health state information may be acquired by linking the service app with other on-line services. Furthermore, when another application that manages the health state of a user is installed in the user terminal 100, the service app may acquire the health state information of a user in linkage with another such application. In addition, a function of managing the health state of a user may be embedded in the service app. The health state information acquired by the user terminal 100 may be transmitted to the service management device 200 as part of the user information, or may be displayed on the service information screen D1 together with the service information acquired from the service management device 200. When it is identified from the health state information that a user is sick, the notification unit 224 may propose that the user not move in the recommended movement method using the second display.

Moreover, for example, a second display D27 is an example of a second display showing information regarding a result of a user moving in the recommended movement method (hereinafter referred to as “movement result information”) as movement-related information. For example, the second display D27 shown in FIG. 6 notifies the user who has reached the destination B by moving in the recommended movement method of a traveling distance and an amount of calories consumed by a movement of that distance. For example, the notification unit 224 may calculate the amount of calories consumed by a movement in the recommended movement method by calculating a movement distance of each movement device from the start point A to the destination B, and taking a sum of results obtained by multiplying each calculated movement distance by the amount of calories per unit distance consumed by each movement device. In this case, the notification unit 224 may calculate the movement distance on the basis of a movement route proposed to the user, or calculate the movement distance on the basis of positional information of the user terminal 100 acquired while the user is moving. Furthermore, in this case, the evaluator 225 may give the target user a reward according to the calculated movement distance or the amount of calories consumed. Furthermore, in this case, the notification unit 224 may notify the user that a reward has been given to the target user using a second display.

For simplicity, FIG. 6 shows an example of the service information screen D1 on which all types of movement-related information regarding the recommended movement method are displayed at the same time, but all types of movement-related information do not necessarily have to be displayed on the service information screen D1 at the same time. For example, the notification unit 224 may be configured to display movement-related information according to a movement status of a user on the service information screen D1. For example, the notification unit 224 may display the movement-related information according to the movement device or movement condition of a user on the service information screen Dl. For example, when it is estimated that an arrival at the destination B will not be in time for a time set as a movement condition by using a movement-related service, the notification unit 224 may also display movement-related information regarding such a movement-related service on the service information screen D1. Furthermore, for example, the notification unit 224 may display movement-related information regarding a point within a predetermined range from a current position of a user on the service information screen D1.

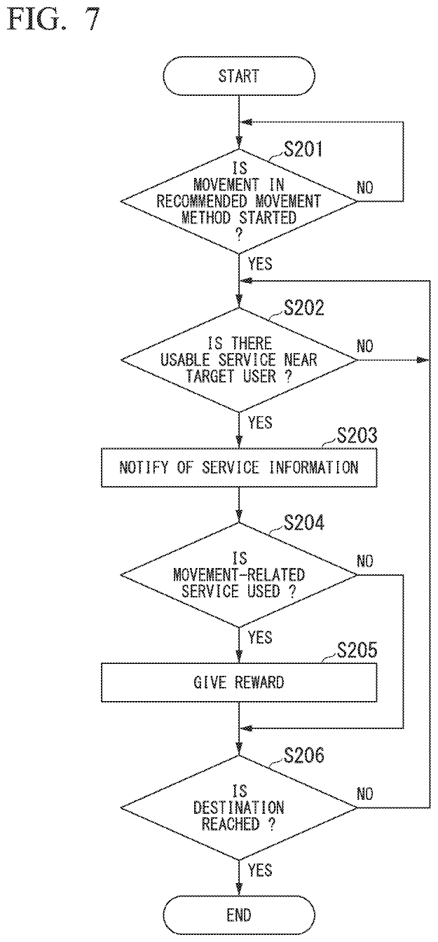

FIG. 7 is a flowchart that shows an example of processing in which the service management device 200 of the present embodiment gives various rewards according to the movement of a user in a recommended movement method (hereinafter referred to as “first reward granting processing”). In addition, here, a case in which the movement-related information regarding a movement-related service is notified to a target user according to a current position of the target user will be described. Furthermore, here, it is assumed that user information including the positional information is periodically transmitted from the user terminal 100 to the service management device 200 until the target user reaches a destination from a start point in a recommended movement method.

First, the notification unit 224 determines whether the target user has started the movement in the recommended movement method (step S201). Here, when it is determined that the target user has not started the movement in the recommended movement method, the notification unit 224 repeatedly executes step S201 until it is determined that the target user has started the movement in the recommended movement method. On the other hand, when it is determined that the target user has started the movement in the recommended movement method in step S201, the notification unit 224 determines whether a provision location of an available service is near the target user on the basis of the provider information and current position of the target user (step S202).

Here, when it is determined that a provision location of a service available for the target user is not near the target user, the notification unit 224 repeatedly executes step S202 until the provision location of an available service is found near the target user. On the other hand, when it is determined that the provision location of a service available for the target user is near the target user in step S202, the notification unit 224 generates service information regarding the movement-related service and notifies the user terminal 100 of the information (Step S203).

If the user terminal 100 is notified of the service information by the notification unit 224, the evaluator 225 subsequently determines whether a movement-related service of which the user terminal 100 is notified has been used by the target user (step S204). For example, when a notification that the movement-related service has been used by the target user (hereinafter referred to as a “service usage notification”) is provided to the service management device 200 by the service provider 300, the evaluator 225 can determine whether the movement-related service of which the user terminal 100 is notified has been used by the target user depending on whether the service usage notification for the target user has been received. The service management device 200 may be notified of the service usage notification not from the service provider 300 but from the user terminal 100 of a user who has used the movement-related service.

In step S204, when it is determined that the movement-related service has been used by the target user, the evaluator 225 gives a reward to the service provider 300 that has provided the movement-related service to the target user or a target user who has used the movement-related service according to the movement-related service (step S205). In this case, for example, it is assumed that content of the reward given to the user or the service provider 300 is registered in the provider information in advance for each movement-related service. In this case, the evaluator 225 specifies the content of a reward corresponding to the notified movement-related service on the basis of the provider information, and gives a reward of the specified content to the target user or the service provider 300.

On the other hand, when it is determined that a movement-related service has not been used by the target user in step S204, the evaluator 225 advances the processing to step S206 without executing step S205. It may take some time for the target user to use a movement-related service after the target user is notified of the movement-related service. For this reason, the evaluator 225 may advance the processing to step S206 when it has been repeatedly determined a predetermined number of times in step S204 that the movement-related service has not been used by the target user.

Subsequently, the evaluator 225 determines whether the target user has reached a destination in step S206. Here, when it is determined that the target user has not reached the destination, the evaluator 225 returns the processing to step S202, and repeatedly executes the processing from steps S202 to S206. On the other hand, when it is determined that the target user has reached the destination in step S206, the evaluator 225 ends the reward granting processing.

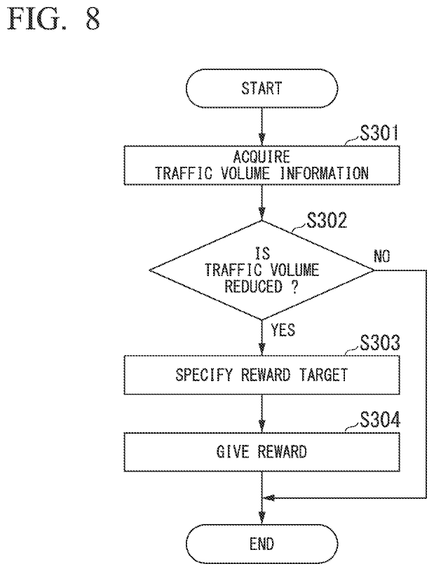

Here, although an example is shown in which the reward granting processing is performed during the movement of the target user, the reward granting processing does not necessarily have to be performed during the movement of the target user. For example, in a case of giving a reward on the basis of a result of a recommended movement by the target user, the reward granting processing may be executed after the recommended movement by the target user is completed. FIG. 8 is a flowchart which shows an example of the reward granting processing executed after the recommended movement by the target user is completed (hereinafter, referred to as “second reward granting processing”.) Here, for example, a case in which processing of giving a reward according to a degree of contribution in reduction of traffic volume around a movement route, caused by the recommended movement of a user, is set as second reward granting processing will be described.

An execution timing of the second reward granting processing is arbitrary. For example, the second reward granting processing may be executed at predetermined intervals for a movement in a recommended movement method performed within each period. In this case, it is assumed that the acquirer 221 acquire user information regarding the movement in the recommended movement method from each user terminal 100 and associate the acquired user information with the recommended movement method to save a result in the storage 230 as user management information such that the recommended movement method to be processed can be identified after the movement in the recommended movement method is performed.

In this case, first, the evaluator 225 acquires information indicating a traffic volume generated in an evaluation target period in an evaluation target area (hereinafter, referred to as “traffic volume information”) (step S301). For example, traffic volume information may be acquired from a traffic information system operated by an administration of municipalities or road operators. Moreover, the evaluation target period may be arbitrarily set according to a frequency or the like at which the second reward granting processing is executed. For example, when the second reward granting processing is executed once a day, the evaluation target period may be set to the past 24 hours. In this case, the evaluator 225 acquires traffic volume information indicating a traffic volume generated in the past 24 hours in an evaluation target area. The evaluation target area may be arbitrarily set in accordance with a range within which traffic volume information can be acquired. Note that the traffic volume information may indicate statistical values of traffic volume in an evaluation target period (for example, an average value, a median value, a mode value, a maximum value, a minimum value, and the like), or may also indicate a transition in traffic volume in an evaluation target period.

Subsequently, the evaluator 225 determines whether a traffic volume of an evaluation target period in an evaluation target area has decreased as compared to a traffic volume before the evaluation target period on the basis of the acquired traffic volume information (step S302). For example, the evaluator 225 determines whether the traffic volume in an evaluation target period has decreased as compared to the traffic volume in a comparison target period. Here, the comparison target period is a period including a period prior to the evaluation target period. The comparison target period may or may not include the evaluation target period.

In this case, the evaluator 225 acquires the traffic volume information of the comparison target period in addition to the traffic volume information of the evaluation target period, and compares the traffic volumes with each other, indicated by both types of traffic volume information, to determine whether the traffic volume has decreased. When the traffic volume information indicates the transition in traffic volume, the evaluator 225 may calculate the statistical values of traffic volume based on the traffic volume information to compare statistical values with each other, or may also calculate a total traffic volume based on the traffic volume information to compare traffic volumes with each other. Moreover, in this case, the evaluator 225 may compare between traffic volumes of respective time points indicated by the traffic volume information. When the traffic volumes at each time point are compared, a criteria for determining that the traffic volume has decreased may be arbitrarily set. For example, the evaluator 225 may determine that the traffic volume has decreased when the traffic volume of the evaluation target period is less than the traffic volume of the comparison target period at all time points, or may also determine that the traffic volume has decreased when the number of time points at which the traffic volume of the evaluation target period is less than the traffic volume of the comparison target period is a predetermined number (for example, a majority) or more.

In step S302, when it is determined that the traffic volume of the evaluation target period in the evaluation target area has decreased as compared to the traffic volume before the evaluation target period, the evaluator 225 specifies a target (hereinafter, referred to as a “reward target”) to give a reward for contributing to a reduction in traffic volume (step S303), and gives a reward to the specified reward target (step S304). The evaluator 225 may give a reward of predetermined contents to the reward target, or may give a reward of contents in accordance with the degree of contribution of the reward target to the reduction in traffic volume. On the other hand, when it is determined in step S302 that the traffic volume of the evaluation target period in the evaluation target area has not decreased as compared to the traffic volume before the evaluation target period, the evaluator 225 ends the second reward granting processing without executing steps S303 and S304.

For example, the reward target may be the service provider 300. In this case, the evaluator 225 may specify the service provider 300 that provides a movement-related service in the evaluation target area as the reward target, or may specify a service provider 300 that has actually provided a movement-related service in the evaluation target period among these service providers 300 as the reward target. For example, the evaluator 225 may give a reward of predetermined contents to each service provider 300, or may also give a reward according to a provision achievement of a movement-related service provided by each service provider 300 in the evaluation target period. For example, the evaluator 225 may give a reward of contents different for each movement-related service, may give a reward according to sales made by provision of a movement-related service, or may also give a reward according to the number of times a movement-related service is provided.

In addition, for example, the reward target may be a user who has moved in a recommended movement method. In this case, the evaluator 225 may specify the user who has moved in the recommended movement method within the evaluation target period in the evaluation target area as the reward target, or may also specify a user who has used a movement-related service in the middle of a movement route among these users as the reward target. For example, the evaluator 225 may give a reward of predetermined contents to each user of the reward target, or may also give a reward of contents according to an achievement of a movement performed by each user or an usage achievement of a movement-related service used by each user during the movement. For example, the evaluator 225 may give a reward of contents according to the movement distance of a user, or may give a reward of contents according to the movement-related service used by a user during the movement.

When a reward for the purpose of reducing a traffic volume is given to a user or a service provider 300 by performing such second reward granting processing, the determiner 223 of the service management device 200 may be configured to propose to the user a movement device that further reduces the traffic volume as a recommended movement method. For example, when the target movement method is a method with a car set as a movement device, the determiner 223 may propose a recommended movement method with a bicycle or walking set as a movement device.

The movement-related service providing system 1 of the embodiment configured in this manner includes the service management device 200 that determines a recommended movement method to be proposed to a target user on the basis of a movement method that the target user or another user has performed in the past, and thereby it is possible to propose to the user a movement method that can replace a usual movement method in a timely manner.

Moreover, in the movement-related service providing system 1 of the embodiment, the service management device 200 proposes to a user a movement-related service that the user can use during the movement together with a recommended movement method, and thereby it is possible to improve the added value of a movement time of the target user. Specifically, according to the movement-related service providing system 1 of the embodiment, a user can move a section in which he/she often moves in an unusual recommended movement method proposed by the movement-related service providing system 1, and can set a time required to move the section as a time with a higher added value. For example, the user can set a daily commuting time as a time with a higher added value.

Moreover, in the movement-related service providing system 1 of the embodiment, the service management device 200 can provide a user and a service provider 300 with a reward according to a content of a movement performed by each user. For this reason, according to the movement-related service providing system 1 of the embodiment, it is possible to improve a motivation of the user to move in a recommended movement method, and it is also possible to improve a motivation of the service provider 300 to provide a better movement-related service. Then, by improving the motivation of the user and the service provider 300, more users will move in the recommended movement method, and thus, a traffic volume near a movement route can be reduced.

The embodiment described as above can be expressed as follows.

An information processing device includes a storage device that stores a program, and a hardware processor, and is configured to, by the hardware processor executing a program stored in the storage device, acquire user information regarding a movement of a user from a user terminal used by the user, estimate a first movement method for the user based on the user information, determine a third movement method different from the first movement method on the basis of a second movement method that is a movement method performed in the past by the user or another user having a movement history similar to that of the user, and notify the user of the third movement method before the user starts the movement in the first movement method.

Although the embodiments for carrying out the present invention have been described above using the embodiments, the present invention is not limited to these embodiments, and various modifications and substitutions are made without departing from the gist of the present invention.

What is claimed is:

1. An information processing device comprising:
an acquirer configured to acquire user information regarding a movement of a user from a user terminal used by the user;
an estimator configured to estimate a first movement method of the user on the basis of the user information;
a determiner configured to determine a third movement method different from the first movement method on the basis of a second movement method that is a movement method performed in the past by the user or another user having a movement history similar to a movement history of the user; and
a notification unit configured to notify the user of the third movement method before the user starts a movement in the first movement method.

2. The information processing device according to claim 1,
wherein the user information includes at least section information, and
the determiner extracts a movement history that has the same start point and destination and has a short movement distance from the start point to the destination as the movement history similar to the movement history of the user.

3. The information processing device according to claim 1,
wherein the determiner determines the third movement method on the basis of a movement time required for a movement in the second movement method.

4. The information processing device according to claim 1,
wherein the determiner determines the third movement method on the basis of a charge required for a movement in the second movement method.

5. The information processing device according to claim 1,
wherein the determiner determines the third movement method on the basis of a service that is usable as the user moves.

6. The information processing device according to claim 5, further comprising:
a reward granting unit configured to perform processing for giving a reward in accordance with an achievement of the user using the service to a provider of the service.

7. The information processing device according to claim 1,
wherein the determiner determines the third movement method of each of a plurality of users such that a traffic volume in an area to which the users move is reduced by the plurality of users performing a movement in the third movement method of which each user is notified.

8. An information processing method comprising:
by a computer,
acquiring user information regarding a movement of a user from a user terminal used by the user;
estimating a movement method of the user as a first movement method on the basis of the user information;
determining a third movement method different from the first movement method on the basis of a second movement method that is a movement method performed in the past by the user or another user having a movement history similar to a movement history of the user; and
notifying the user of the third movement method before the user starts a movement in the first movement method.

9. A computer readable non-transitory storage medium that stores a program for causing a computer to execute:
acquiring user information regarding a movement of a user from a user terminal used by the user;
estimating a movement method of the user as a first movement method on the basis of the user information;
determining a third movement method different from the first movement method on the basis of a second movement method that is a movement method performed in the past by the user or another user having a movement history similar to a movement history of the user; and
notifying the user of the third movement method before the user starts a movement in the first movement method.
